(19) United States
(12) Patent Application Publication
(10) Pub. No.: US 2021/0008944 A1
(43) Pub. Date: Jan. 14, 2021

(54) DAMPER CONTROL SYSTEM AND METHOD FOR VEHICLES

(71) Applicants: Hyundai Motor Company, Seoul (KR); Kia Motors Corporation, Seoul (KR)

(72) Inventors: Min Su LEE, Seongnam-si (KR); Seong Jun Choi, Incheon (KR)

(73) Assignees: Hyundai Motor Company, Seoul (KR); Kia Motors Corporation, Seoul (KR)

(21) Appl. No.: 16/683,628

(22) Filed: Nov. 14, 2019

(30) Foreign Application Priority Data
Jul. 8, 2019 (KR) 10-2019-0082312

(51) Int. Cl. B60G 17/016; B60G 17/018; B60G 21/055

(52) U.S. Cl. CPC B60G 17/0162; B60G 17/018; B60G 21/0555; B60G 2400/0522; B60G 2400/102; B60G 2400/0521; B60G 2400/412

(57) ABSTRACT

Disclosed are a damper control system and method for vehicles in which speeds of suspension dampers optimized for ECS control may be derived, and wheel G sensors to derive the damper speeds may be omitted, reducing material costs.

### CROSS-REFERENCE TO RELATED APPLICATION

The present application claims priority to Korean Patent Application No. 10-2019-0082312, filed on Jul. 8, 2019 in the Korean Intellectual Property Office, the entire contents of which is incorporated herein for all purposes by this reference.

### BACKGROUND OF THE INVENTION

### Field of the Invention

The present invention relates to a damper control system and method for vehicles, and more particularly to a damper control system and method for vehicles which reduce movement of a suspension.

### Description of Related Art

Recently, an electronically controlled suspension (ECS), which minimizes the vertical movement of a vehicle body (sprung mass) and thus improves riding comfort by controlling dampers to compensate for the relative speed of the suspension, has been used.

The conventional ECS includes four dampers which provide damping force between the vehicle body and wheels, an electric control unit (ECU) which controls the dampers, vehicle body sensor units which determine the vertical speed of the vehicle body, and wheel sensor units which determine the vertical speed of the wheels.

Here, the vehicle sensor units are mounted on three corners of the four corners of the vehicle body, and the wheel sensor units are mounted on the two front wheels, and thus a total of five sensor units is required.

However, the sensor units mounted on the vehicle body and the wheels are expensive, and mounting of these sensor units increases the weight of the vehicle and thus has a negative influence on fuel economy.

Therefore, a new damper control method which may maintain the improvement in riding comfort realized by the ECS while reducing the number of sensor units compared to the conventional method is required.

The information included in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a damper control system and method for vehicles which may control dampers using a small number of sensor units.

In accordance with an aspect of the present invention, the above and other objects can be accomplished by the provision of a damper control apparatus of vehicles including an estimation unit configured to receive vertical accelerations of a vehicle body above respective wheels of the vehicle, measured through sensor units, and to estimate vertical speeds of the vehicle body above the respective wheels using the vertical accelerations of the vehicle body, a derivation unit configured to derive forces acting on regions above respective front wheels of the respective wheels using the vertical speeds of the vehicle body derived through the estimation unit, a first calculation unit configured to determine relative vertical speeds of the respective front wheels with respect to the vertical speeds of the vehicle body above the respective front wheels using the forces acting on the regions above the respective front wheels, and to determine vertical speeds of the respective front wheels using the relative vertical speeds of the respective front wheels, a second calculation unit configured to estimate vertical speeds of respective rear wheels of the respective wheels after a delay of a specific time using the vertical speeds of the respective front wheels determined by the first calculation unit, and to determine relative vertical speeds of the respective rear wheels with respect to the vertical speeds of the vehicle body above the respective rear wheels, and a controller configured to control dampers of front wheel suspensions and rear wheel suspensions using the relative vertical speeds of the respective wheels derived by the first calculation unit and the second calculation unit.

The damper control system may further include a situation determination unit configured to receive steering information about a steering angle or a steering angular speed and to compare the steering angle or the steering angular speed with a predetermined reference steering value, and if the steering angle or the steering angular speed is equal to or less than the predetermined reference steering value, the situation determination unit may determine that the vehicle is in a non-steering situation and estimate speeds of the dampers of the front and rear wheel suspensions.

The situation determination unit may further receive driving speed information of the vehicle, and determine whether or not the vehicle is in the non-steering situation, if a driving speed of the vehicle is equal to or more than a predetermined reference speed value.

If a roll rate and a pitch rate measured through the sensor units are equal to or more than respective reference boundary values, the situation determination unit may determine that the vehicle is in an abnormal state and may not estimate the speeds of the dampers of the front and rear wheel suspensions.

The sensor unit may include a 6D sensor, the 6D sensor may measure a vertical acceleration of a center of mass of the vehicle body, a roll rate and a pitch rate, and the estimation unit may derive the vertical speeds of the vehicle body above the respective wheels using the vertical acceleration of the center of mass of the vehicle body, the roll rate and the pitch rate.

The sensor unit may include a body G sensor installed at each of three sections among a total of four sections of the vehicle body provided with the wheels, and the estimation unit may estimate the vertical accelerations of the vehicle body above the wheels through the body G sensors.

The estimation unit may receive the vertical accelerations of the three sections among the four sections of the vehicle body above the wheels, measured through the body G sensors, derive a vertical speed of a center of mass of the vehicle body using the vertical accelerations of the three sections of the vehicle body above the wheels, and determine a vertical speed of the remaining one section among the four sections of the vehicle body above the respective wheels using the vertical speed of the center of mass of the vehicle body, a roll rate and a pitch rate.

The estimation unit may determine the vertical speed of the center of mass of the vehicle body using the following Equations.

v_{bz_FL}=v_{cz_est}+t1·\dot{φ}−a·\dot{ϕ}

v_{bz_FR}=v_{cz_est}−t1·\dot{φ}−a·\dot{ϕ}

v_{bz RL}=v_{cz est}+t2·\dot{φ}+b·\dot{ϕ}

v_{cz_est}=0.5·(v_{bz_FL}+v_{bz_FR}+2·a·\dot{ϕ})

Here, v_{bz_FL} may be the vertical speed [m/s] of the vehicle body above the front left wheel, v_{bz_FR} may be the vertical speed [m/s] of the vehicle body above the front right wheel, v_{bz_RL} may be the vertical speed [m/s] of the vehicle body above the rear left wheel, v_{cz_est} may be the vertical speed [m/s] of the center of mass of the vehicle body, t1 may be a front wheel tread [m], t2 may be a rear wheel tread [m], a may be a distance [m] from the center of mass of the vehicle body to a front shaft, b may be a distance [m] from the center of mass of the vehicle body to a rear shaft, ϕ may be a roll angle [rad], and φ may be a pitch angle [rad].

The estimation unit may determine the roll rate and the pitch rate using the following Equations.

$$\dot{ϕ} = - 0.5 / t 1 \cdot ( {v}_{bz\_FL} - {v}_{bz\_FR} )$$

$$\dot{φ} = 0.5 / ( a + b ) \cdot {( {v}_{bz\_FL} - {v}_{bz\_FR} )}^{t 2} \cdot 0.5 / ( t 1 \cdot ( a + b ) ) \cdot ( {v}_{bz\_FL} - {v}_{bz\_FR} ) + 1 / ( a + b ) \cdot {v}_{bz\_FL}$$

The estimation unit may determine the vertical speed of the remaining one section among the four sections of the vehicle body using the vertical speed of the center of mass of the vehicle body, the roll rate and the pitch rate, through the following Equation.

v_{bz_RR}=v_{cz_est}−t2·\dot{φ}+b·\dot{ϕ}

Here, v_{cz_RR} may be the vertical speed [m/s] of the vehicle body above the rear right wheel.

The derivation unit may derive the vertical accelerations of the vehicle body above the respective rear wheels by integrating the vertical speeds of the vehicle body above the respective rear wheels, and derive forces acting on regions above the respective rear wheels using the vertical accelerations of the vehicle body above the rear wheels.

The first calculation unit may determine force acting on a rear left suspension and force acting on a rear right suspension using the following Equations.

$${F}_{z\_RL} = {a}_{bz\_RL} \cdot \frac{{m}_{3}}{4}$$

$${F}_{z\_RR} = {a}_{bz\_RR} \cdot \frac{{m}_{3}}{4}$$

Here, F_{z_RL} may be the force (N) acting on the rear left suspension, F_{z_RR} may be the force (N) acting on the rear right suspension, a_{bz_RL} may be the vertical acceleration of the vehicle body above the rear left wheel, a_{bz_RR} may be the vertical acceleration of the vehicle body above the rear right wheel, and mₛ may be a sprung mass (kg).

The first calculation unit may derive the forces acting on the regions above the respective front wheels depending on a situation in which the roll rate and the pitch rate occur, and determine the relative vertical speeds of the respective front wheels with respect to the vertical speeds of the vehicle body above the respective front wheels using the forces acting on the regions above the respective front wheels.

The first calculation unit may determine the forces acting on the regions above the respective front wheels depending on the roll rate and the pitch rate using the following Equations.

Roll Rate Equation:

Iₓ·\ddot{φ}=t1·(F_{z_FL} F_{z_FR})|t2·(F_{z_RL} F_{z_RR})

Pitch Rate Equation:

$${I}_{v} \cdot \ddot{θ} = - a \cdot ( {F}_{z\_FL} + {F}_{z\_FR} ) + b \cdot ( {F}_{z\_RL} + {F}_{z\_RR} )$$

$${F}_{z FL} = ( {I}_{x} \cdot \ddot{ϕ} - t 2 \cdot ( {F}_{z\_RL} + {F}_{z\_RR} ) ) / t 1 + {F}_{z\_FR}$$

$${F}_{z\_FL} = ( {I}_{x} \cdot \ddot{ϕ} - t 2 \cdot ( {F}_{z\_RL} + {F}_{z\_RR} ) ) / t 1 + {F}_{z\_FR}$$

$${F}_{z\_FR} = \frac{( {-}^{( {I}_{y} \cdot \ddot{θ} - b \cdot ( {F}_{z\_RL} + {F}_{z\_RR} ) )} / {α}^{- ( {I}_{x} \cdot \ddot{ϕ} - t 2 \cdot ( {F}_{z\_RL} + {F}_{z\_RR} ) )} t 1 )}{2}$$

$${F}_{z\_FR} = \frac{( {-}^{( {I}_{y} \cdot \ddot{θ} - b \cdot ( {F}_{z\_RL} + {F}_{z\_RR} ) )} / {α}^{- ( {I}_{x} \cdot \ddot{ϕ} - t 2 \cdot ( {F}_{z\_RL} + {F}_{z\_RR} ) )} t 1 )}{2}$$

Here, Iₓ may be roll inertia (kgm\hat{ }2), I_{y} is pitch inertia (kgm\hat{ }2), F_{z_RL} may be the force (N) acting on the rear left suspension, and F_{z_RR} may be the force (N) acting on the rear right suspension.

The first calculation unit may determine the relative vertical speeds of the respective front wheels with respect to the vertical speeds of the vehicle body above the respective front wheels using the following Equations.

$$Δ {\dot{x}}_{FL} = ( {F}_{zFL} - {k}_{FL} \cdot Δ {x}_{FL} ) / {b}_{FL}$$

$$Δ {\dot{x}}_{FR} = ( {F}_{zFR} - {k}_{FR} \cdot Δ {x}_{FR} ) / {b}_{FR}$$

Here, Δ\dot{x}_{FL} may be the relative vertical speed (m/s) of the front left wheel, Δ\dot{x}_{FR} may be the relative vertical speed (m/s) of the front right wheel, k_{FL} may be spring rigidity (N/m) of the front left suspension, k_{FR} may be spring rigidity (N/m) of the front right suspension, b_{FL} may be a front left damping coefficient (Ns/m), and b_{FR} may be a front right damping coefficient (Ns/m).

The second calculation unit may determine the vertical speeds of the respective front wheels using the relative vertical speeds of the respective front wheels, derive a delay caused by a wheelbase between the front and rear wheels and a vehicle speed, derive the vertical speeds of the respective rear wheels after the delay compared to the vertical speeds of the respective front wheels, and determine the relative vertical speeds of the respective rear wheels with respect to the vertical speeds of the vehicle body above the respective rear wheels using the vertical speeds of the respective rear wheels.

The second calculation unit may derive the vertical speeds of the respective rear wheels after the delay, and determine the relative vertical speeds of the respective rear wheels with respect to the vertical speeds of the vehicle body above the respective rear wheels, using the following Equations.

$$delay = \frac{2 + b}{{υ}_{x}}$$

$${\dot{x}}_{usFL} = Δ {\dot{x}}_{FL} + {\dot{x}}_{sFL}$$

$${\dot{x}}_{usFR} = Δ {\dot{x}}_{FR} + {\dot{x}}_{sFR}$$

$${\dot{x}}_{us\_RL} = \frac{a + b}{{υ}_{x}} ( {\dot{x}}_{us\_FL} ) = {\dot{x}}_{us\_FL}$$

$${\dot{x}}_{us\_RR} = \frac{a + b}{{υ}_{x}} ( {\dot{x}}_{us\_FR} ) = {\dot{x}}_{us\_FR}$$

$$Δ {\dot{x}}_{RL} = {\dot{x}}_{us\_RL} - {\dot{x}}_{s\_RL}$$

$$Δ {\dot{x}}_{RR} = {\dot{x}}_{us\_RR} - {\dot{x}}_{s\_RR}$$

Here, \dot{x}_{us_FL} may be the vertical speed (m/s) of the front left wheel, \dot{x}_{us_FR} may be the vertical speed (m/s) of the front right wheel, \dot{x}_{us_RL} may be the vertical speed (m/s) of the rear left wheel, \dot{x}_{us_RR} may be a vertical speed (m/s) of the rear right wheel, Δ\dot{x}_{RL} may be the relative vertical speed (m/s) of the rear left wheel, and Δ\dot{x}_{RR} may be the relative vertical speed (m/s) of the rear right wheel.

In accordance with another aspect of the present invention, there is provided a damper control method for vehicles including measuring vertical accelerations of a vehicle body above respective wheels through sensor units, estimating vertical speeds of the vehicle body above the respective wheels using the vertical accelerations of the vehicle body, deriving forces acting on regions above respective front wheels of the respective wheels using the vertical speeds of the vehicle body derived through the estimating, primarily determining relative vertical speeds of the respective front wheels with respect to the vertical speeds of the vehicle body above the respective front wheels using the forces acting on the regions above the respective front wheels and determining vertical speeds of the respective front wheels using the relative vertical speeds of the respective front wheels, estimating vertical speeds of respective rear wheels of the respective wheels after a delay of a specific time using the vertical speeds of the respective front wheels determined through the primarily determining and secondarily determining relative vertical speeds of the respective rear wheels with respect to the vertical speeds of the vehicle body above the respective rear wheels, and controlling dampers of front wheel suspensions and rear wheel suspensions using the relative vertical speeds of the respective wheels derived in the primarily determining and the estimating and secondarily determining.

The damper control method may further include receiving steering information about a steering angle or a steering angular speed and comparing the steering angle or the steering angular speed with a predetermined reference steering value, and in the receiving the steering information and the comparing the steering angle or the steering angular speed with the predetermined reference steering value, if the steering angle or the steering angular speed is equal to or less than the predetermined reference steering value, the vehicle may be determined to be in a non-steering situation and the speeds of the dampers of the front and rear wheel suspensions may be estimated.

In the receiving the steering information and the comparing the steering angle or the steering angular speed with the predetermined reference steering value, driving speed information of the vehicle may be further received, whether or not the vehicle is in the non-steering situation may be determined, if a driving speed of the vehicle is equal to or more than a predetermined reference speed value, a and it may be determined that the vehicle is in an abnormal state and the speeds of the dampers of the front and rear wheel suspensions may not be not estimated, if a roll rate and a pitch rate measured through the sensor units are equal to or more than respective reference boundary values.

In the measuring the vertical accelerations of the vehicle body above the respective wheels, the sensor unit may include one of a 6D sensor and a body G sensor, if the sensor unit includes the 6D sensor, the 6D sensor may measure a vertical acceleration of a center of mass of the vehicle body, a roll rate and a pitch rate, if the sensor unit includes the body G sensor, the body G sensor may be installed at each of three sections among a total of four sections of the vehicle body provided with the wheels, and in the estimating the vertical speeds of the vehicle body above the respective wheels, the vertical speeds of the vehicle body above the respective wheels may be estimated by receiving information about the vertical acceleration of the center of mass of the vehicle body, the roll rate and the pitch rate through the sensor units.

In the estimating the vertical speeds of the vehicle body above the respective wheels, the vertical accelerations of the three sections among the four sections of the vehicle body above the wheels, measured through the sensor units, may be received, the vertical speed of the center of mass of the vehicle body may be derived using the vertical accelerations of the three sections of the vehicle body above the wheels, and a vertical speed of the remaining one section among the four sections of the vehicle body above the respective wheels may be determined using the vertical speed of the center of mass of the vehicle body, the roll rate and the pitch rate.

In the estimating the vertical speeds of the vehicle body above the respective wheels, the vertical speed of the center of mass of the vehicle body may be determined using the following Equations.

v_{bz_FL}=v_{cz_est}+t1·\dot{φ}−a·\dot{ϕ}

v_{bz_FR}=v_{cz_est}−t1·\dot{φ}−a·\dot{ϕ}

v_{bz_RL}=v_{cz_est}+t2·\dot{φ}+b·\dot{ϕ}

v_{cz_est}=0.5·(v_{bz_FL}+v_{bz_FR}+2·a·\dot{ϕ})

Here, v_{bz_FL} may be the vertical speed [m/s] of the vehicle body above the front left wheel, v_{bz_FR} may be the vertical speed [m/s] of the vehicle body above the front right wheel, v_{bz_RL} may be the vertical speed [m/s] of the vehicle body above the rear left wheel, v_{cz_est} may be the vertical speed [m/s] of the center of mass of the vehicle body, t1 may be a front wheel tread [m], t2 may be a rear wheel tread [m], a may be a distance [m] from the center of mass of the vehicle body to a front shaft, b may be a distance [m] from the center of mass of the vehicle body to a rear shaft, ϕ may be a roll angle [rad], and φ may be a pitch angle [rad].

In the estimating the vertical speeds of the vehicle body above the respective wheels, the roll rate and the pitch rate may be determined using the following Equations.

$$\dot{ϕ} = - 0.5 / t 1 \cdot ( {v}_{bz\_FL} - {v}_{bz\_FR} ) \dot{ϕ} = - 0.5 / t 1 \cdot ( {v}_{bz\_FL} - {v}_{bz\_FR} )$$

$$\dot{φ} = 0.5 / ( a + b ) \cdot {( {v}_{bz\_FL} + {v}_{bz\_FR} )}^{- t 2} \cdot 0.5 / ( t 1 \cdot ( a + b ) ) \cdot ( {v}_{bz\_FL} - {v}_{bz\_FR} ) + 1 / ( a + b ) \cdot {v}_{bz\_RL}$$

In the estimating the vertical speeds of the vehicle body above the respective wheels, the vertical speed of the remaining one section among the four sections of the vehicle body using the vertical speed of the center of mass of the vehicle body, the roll rate and the pitch rate, through the following Equation.

v_{bz_RR}=v_{cz_est}−t2·\dot{φ}+b·\dot{ϕ}

Here, v_{cz_RR} may be the vertical speed [m/s] of the vehicle body above the rear right wheel.

In the deriving the forces acting on the regions above the respective front wheels, vertical accelerations of the vehicle body above the respective rear wheels may be derived by integrating the vertical speeds of the vehicle body above the rear wheels, and forces acting on the regions above the respective rear wheels may be derived using the vertical accelerations of the vehicle body above the rear wheels.

In the deriving the forces acting on the regions above the respective front wheels, force acting on a rear left suspension and force acting on a rear right suspension may be determined using the following Equations.

$${F}_{z\_RL} = {a}_{bz\_RL} \cdot \frac{{m}_{s}}{4}$$

$${F}_{z\_RR} = {a}_{bz\_RR} \cdot \frac{{m}_{s}}{4}$$

Here, F_{z_RL} may be the force (N) acting on the rear left suspension, F_{z_RR} may be the force (N) acting on the rear right suspension, a_{bz_RL} may be the vertical acceleration of the vehicle body above the rear left wheel, a_{bz_RR} may be the vertical acceleration of the vehicle body above the rear right wheel, and mₛ may be a sprung mass (kg).

In the primarily determining the relative vertical speeds of the respective front wheels and determining the vertical speeds of the respective front wheels, the forces acting on the regions above the respective front wheels depending on a situation in which the roll rate and the pitch rate occur may be derived, and the relative vertical speeds of the respective front wheels with respect to the vertical speeds of the vehicle body above the respective front wheels may be determined using the forces acting on the regions above the respective front wheels.

In the primarily determining the relative vertical speeds of the respective front wheels and determining the vertical speeds of the respective front wheels, the forces acting on the regions above the respective front wheels depending on the roll rate and the pitch rate may be determined using the following Equations.

Roll Rate Equation:

Iₓ·\ddot{φ}=t1·(F_{z_FL}−F_{z_FR})+t2·(F_{z_RL}−F_{z_RR})

Pitch Rate Equation:

$${I}_{v} \cdot \ddot{θ} = - a \cdot ( {F}_{z\_FL} + {F}_{z\_FR} ) + b \cdot ( {F}_{z\_RL} + {F}_{z\_RR} )$$

$${F}_{z\_FL} = ( {I}_{x} \cdot \ddot{ϕ} - t 2 \cdot ( {F}_{z\_RL} - {F}_{z\_RR} ) ) / t 1 + {F}_{z\_FR}$$

$${F}_{z\_FL} = ( {I}_{x} \cdot \ddot{ϕ} - t 2 \cdot ( {F}_{z\_RL} - {F}_{z\_RR} ) ) / t 1 + {F}_{z\_FR}$$

$${F}_{z\_FR} = \frac{( {-}^{( {I}_{y} \cdot θ - b \cdot ( {F}_{z\_RL} - {F}_{z\_RR} ) )} / {a}^{- ( {I}_{x} \cdot \ddot{ϕ} - t 2 \cdot ( {F}_{z\_RL} - {F}_{z\_RR} ) )} / t 1 )}{2}$$

$${F}_{z\_FR} = \frac{( {-}^{( {I}_{y} \cdot θ - b \cdot ( {F}_{z\_RL} - {F}_{z\_RR} ) )} / {a}^{- ( {I}_{x} \cdot \ddot{ϕ} - t 2 \cdot ( {F}_{z\_RL} - {F}_{z\_RR} ) )} / t 1 )}{2}$$

Here, Iₓ may be roll inertia (kgm\hat{ }2), I_{y} is pitch inertia (kgm\hat{ }2), F_{z_RL} may be the force (N) acting on the rear left suspension, and F_{z_RR} may be the force (N) acting on the rear right suspension.

In the primarily determining the relative vertical speeds of the respective front wheels and determining the vertical speeds of the respective front wheels, the relative vertical speeds of the respective front wheels with respect to the vertical speeds of the vehicle body above the respective front wheels may be determined using the following Equations.

$$Δ {\dot{x}}_{FL} = ( {F}_{zFL} - {k}_{FL} \cdot Δ {x}_{FL} ) / {b}_{FL} Δ {\dot{x}}_{FL} = ( {F}_{zFL} - {k}_{FL} \cdot Δ {x}_{FL} ) / {b}_{FL}$$

$$Δ {\dot{x}}_{FL} = ( {F}_{zFL} - {k}_{FL} \cdot Δ {x}_{FL} ) / {b}_{FL} Δ {\dot{x}}_{FL} = ( {F}_{zFL} - {k}_{FL} \cdot Δ {x}_{FL} ) / {b}_{FL}$$

$$Δ {\dot{x}}_{FL} = ( {F}_{zFL} - {k}_{FL} \cdot Δ {x}_{FL} ) / {b}_{FL} Δ {\dot{x}}_{FL} = ( {F}_{zFL} - {k}_{FL} \cdot Δ {x}_{FL} ) / {b}_{FL}$$

$$Δ {\dot{x}}_{FR} = ( {F}_{zFR} - {k}_{FR} \cdot Δ {x}_{FR} ) / {b}_{FR} Δ {\dot{x}}_{FR} = ( {F}_{zFR} - {k}_{FR} \cdot Δ {x}_{FR} ) / {b}_{FR}$$

$$Δ {\dot{x}}_{FR} = ( {F}_{zFR} - {k}_{FR} \cdot Δ {x}_{FR} ) / {b}_{FR}$$

Here, Δ\dot{x}_{FL} may be the relative vertical speed (m/s) of the front left wheel, Δ\dot{x}_{FR} may be the relative vertical speed (m/s) of the front right wheel, k_{FL} may be spring rigidity (N/m) of the front left suspension, k_{FR} may be spring rigidity (N/m) of the front right suspension, b_{FL} may be a front left damping coefficient (Ns/m), and b_{FR} may be a front right damping coefficient (Ns/m).

In the estimating the vertical speeds of the respective rear wheels after the delay and secondarily determining the relative vertical speeds of the respective rear wheels, the vertical speeds of the respective front wheels may be determined using the relative vertical speeds of the respective front wheels, a delay caused by a wheelbase between the front and rear wheels and a vehicle speed may be derived, the vertical speeds of the respective rear wheels after the delay compared to the vertical speeds of the respective front wheels may be derived, and the relative vertical speeds of the respective rear wheels with respect to the vertical speeds of the vehicle body above the respective rear wheels may be determined using the vertical speeds of the respective rear wheels.

In the estimating the vertical speeds of the respective rear wheels after the delay and secondarily determining the relative vertical speeds of the respective rear wheels, the vertical speeds of the respective rear wheels after the delay may be derived and the relative vertical speeds of the respective rear wheels with respect to the vertical speeds of the vehicle body above the respective rear wheels may be determined, using the following Equations.

$$delay = \frac{a + b}{{υ}_{x}} delay = \frac{a + b}{{υ}_{x}}$$

$${\dot{x}}_{usFL} = Δ {\dot{x}}_{FL} + {\dot{x}}_{sFL} {\dot{x}}_{usFL} = Δ {\dot{x}}_{FL} + {\dot{x}}_{sFL}$$

$${\dot{x}}_{usFR} = Δ {\dot{x}}_{FR} + {\dot{x}}_{sFR} {\dot{x}}_{usFR} = Δ {\dot{x}}_{FR} + {\dot{x}}_{sFR}$$

$${\dot{x}}_{us\_RL} = \frac{a + b}{{υ}_{x}} ( {\dot{x}}_{us\_FL} ) = {\dot{x}}_{ux\_FL} {\dot{x}}_{us\_RL} = \frac{a + b}{{υ}_{x}} ( {\dot{x}}_{us\_FL} ) = {\dot{x}}_{ux\_FL}$$

$${\dot{x}}_{us\_RR} = \frac{a + b}{{υ}_{x}} ( {\dot{x}}_{us\_FR} ) = {\dot{x}}_{ux\_FR}$$

$${\dot{x}}_{us\_RR} = \frac{a + b}{{υ}_{x}} ( {\dot{x}}_{us\_FR} ) = {\dot{x}}_{ux\_FR}$$

$$Δ {\dot{x}}_{RL} = {\dot{x}}_{us\_RL} - {\dot{x}}_{s\_RL}$$

$$Δ {\dot{x}}_{RR} = {\dot{x}}_{us\_RR} - {\dot{x}}_{s\_RR}$$

Here, \dot{x}_{us_FL} may be the vertical speed (m/s) of the front left wheel, \dot{x}_{us_FR} may be the vertical speed (m/s) of the front right wheel, \dot{x}_{us_RL} may be the vertical speed (m/s) of the rear left wheel, \dot{x}_{us_RR} may be a vertical speed (m/s) of the rear right wheel, Δ\dot{x}_{RL} may be the relative vertical speed (m/s) of the rear left wheel, and Δ\dot{x}_{RR} may be the relative vertical speed (m/s) of the rear right wheel.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a damper control system for vehicles in accordance with various aspects of the present invention;

FIG. 2, FIG. 3 and FIG. 4 are views illustrating vehicle models illustrating the damper control system for vehicles shown in FIG. 1; and

FIG. 5 and FIG. 6 are flowcharts representing a damper control method for vehicles in accordance with various aspects of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the contrary, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, a damper control system and method for vehicle in accordance with embodiments of the present invention will be described with reference to the accompanying drawings.

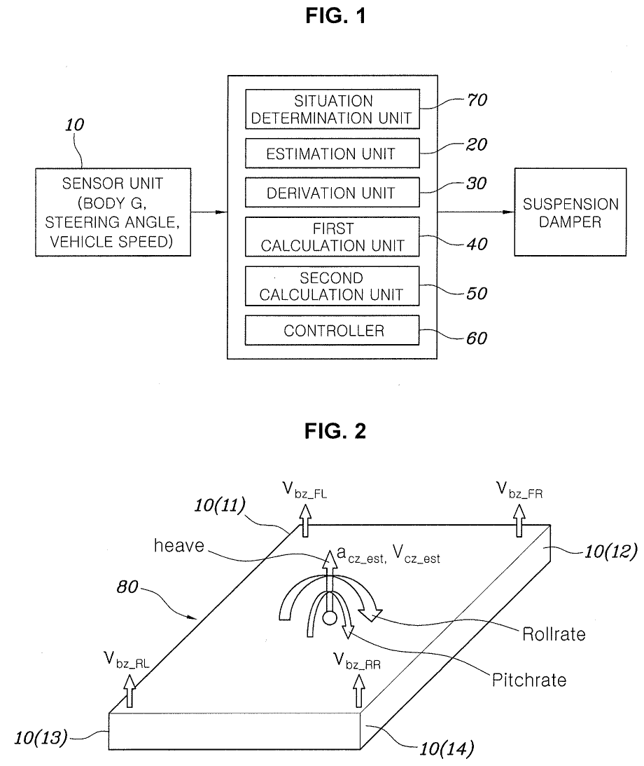

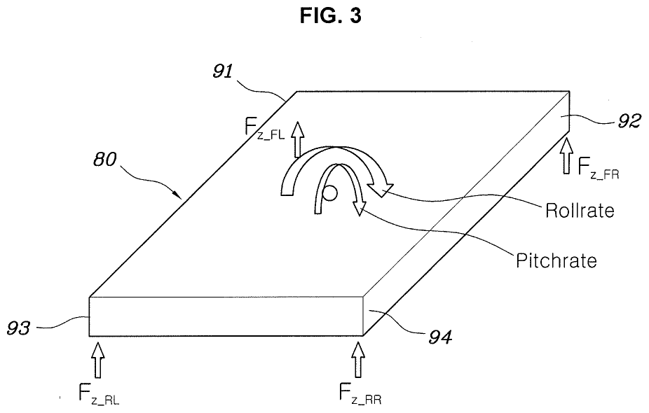

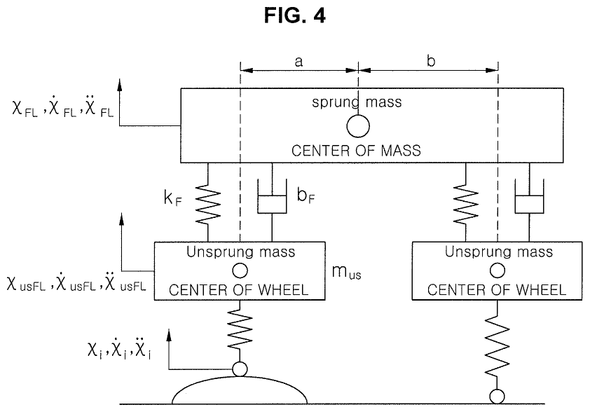

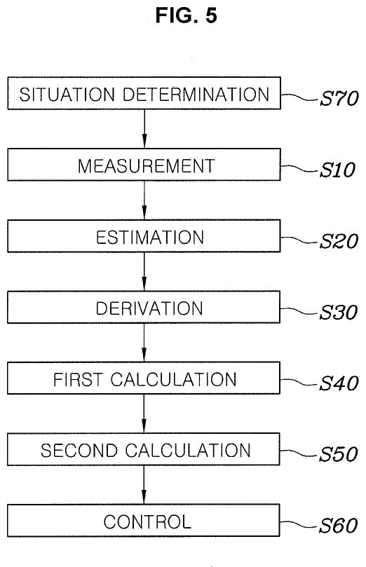

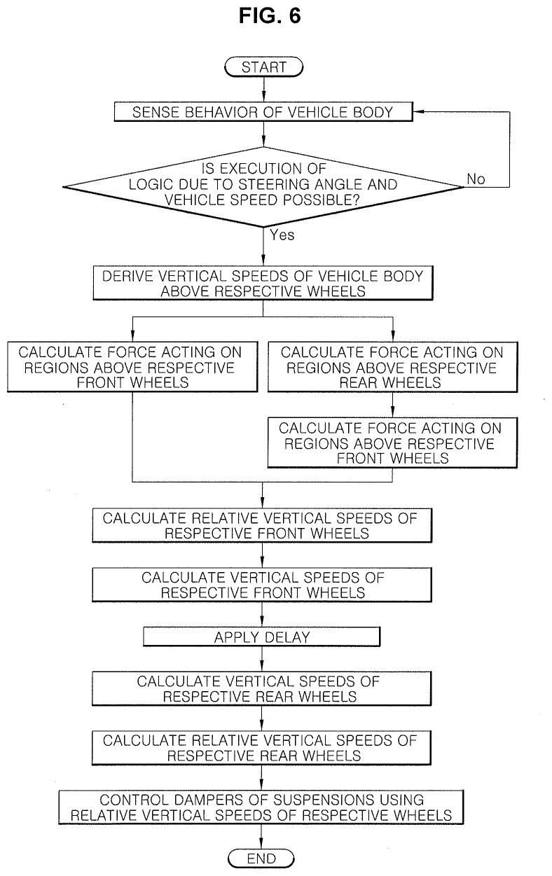

FIG. 1 is a block diagram of a damper control system for vehicles in accordance with various aspects of the present invention, FIG. 2, FIG. 3 and FIG. 4 are views illustrating vehicle models illustrating the damper control system for vehicles shown in FIG. 1, and FIG. 5 and FIG. 6 are flowcharts representing a damper control method for vehicles in accordance with various aspects of the present invention.

The damper control system for vehicles in accordance with various aspects of the present invention includes, as exemplarily shown in FIG. 1, an estimation unit 20 which receives vertical accelerations of a vehicle body above respective wheels of the vehicle, measured through sensor units 10 and estimates vertical speeds of the vehicle body above the respective wheels using the vertical accelerations of the vehicle body, a derivation unit 30 which derives forces acting on regions above respective front wheels of the respective wheels using the vertical speeds of the vehicle body derived through the estimation unit 20, a first calculation unit 40 which determines relative vertical speeds of the respective front wheels with respect to the vertical speeds of the vehicle body above the respective front wheels using the forces acting on regions above the respective front wheels and determines vertical speeds of the respective front wheels using the relative vertical speeds of the respective front wheels, a second calculation unit 50 which estimates vertical speeds of respective rear wheels after a delay of a specific time using the vertical speeds of the respective front wheels determined by the first calculation unit 40 and determines relative vertical speeds of the respective rear wheels with respect to the vertical speeds of the vehicle body above the respective rear wheels, and a controller 60 which controls dampers of front wheel suspensions and rear wheel suspensions using the relative vertical speeds of the respective wheels derived by the first calculation unit 40 and the second calculation unit 50. Here, forces acting on the regions above the wheels may be forces acting on the front and rear wheel suspensions.

The damper control system for vehicles in accordance with various aspects of the present invention is configured to control dampers of the front and rear wheel suspensions using an electronically controlled suspension (ECS), and is configured such that the relative vertical speeds of the respective wheels are derived through a determination process using the estimation unit 20, the derivation unit 30, the first calculation unit 40 and the second calculation unit 50, and the controller 60 controls the dampers of the front wheel suspensions and the rear wheel suspensions using the derived relative vertical speeds of the respective wheels. Here, in order to estimate speeds of the dampers of the suspension, sensors to acquire various pieces of information, such as a steering angle sensor, a vehicle speed sensor, a body G sensor, etc., may be prepared, and a signal processing module which receives various pieces of information from the sensors and then transmits the various pieces of information may be provided. Here, the estimation unit 20, the derivation unit 30, the first calculation unit 40, the second calculation unit 50 and the controller 60 may be integrated as one control module.

The sensor units 10 in accordance with various aspects of the present invention may include a speed sensor for measuring a driving speed of the vehicle, a steering angle sensor for measuring a steering angle of the vehicle, and a body G sensor for detecting a roll rate and a pitch rate of the vehicle body. The body G sensor for estimating the vertical accelerations of the vehicle body above the respective wheels and the vertical speeds of the vehicle body above the respective wheels may be installed at each of four corners of the vehicle body, and if the body G sensors are installed at three corners of the vehicle body, the vertical speeds and the vertical accelerations of the vehicle body at the three corners may be estimated and combined, and thereby, the vertical speed and the vertical acceleration of the vehicle body at a remaining corner may be estimated. Thereby, in an exemplary embodiment of the present invention, the relative vertical speeds of the respective wheels may be determined, and the controller 60 may receive the determined relative vertical speeds of the respective wheels and operate the suspension dampers, being configured for reducing movement of the vehicle body.

In an exemplary embodiment of the present invention, the relative vertical speeds of the respective wheels when the vehicle is driven straight may be derived. For the present purpose, the damper control system for vehicles in accordance with various aspects of the present invention further includes a situation determination unit 70 which receives steering information about a steering angle or a steering angular speed and compares the steering angle or the steering angular speed with a predetermined reference steering value, and if the steering angle or the steering angular speed is equal to or less than the predetermined reference steering value, the situation determination unit 70 may determine that the vehicle is in a non-steering situation and estimate the speeds of the dampers of the front and rear wheel suspensions.

Here, the situation determination unit 70 may receive the steering information from the steering angle sensor, and the reference steering value may be a steering angle value or a steering angular speed value due to manipulation of a steering wheel, with which rotary driving of the vehicle is conducted, and be stored in advance.

If the steering angle or the steering angular speed is the reference steering value or less, the situation determination unit 70 may determine that the vehicle is not steered and thus rotary driving of the vehicle is not conducted, and thereby the speeds of the dampers of the front and rear wheel suspensions may be estimated.

In addition, the situation determination unit 70 may further receive driving speed information of the vehicle, and determine whether or not the vehicle is in the non-steering situation, if the driving speed is equal to or more than a predetermined reference speed value. Here, the reference speed value may be predetermined in consideration of the driving speed to determine whether or not the vehicle is driven, and if the driving speed is the reference speed value or more, the situation determination unit 70 may determine whether or not the vehicle is in the non-steering state and perform control thereby.

Furthermore, if the roll rate and the pitch rate measured by the sensor units 10 are equal to or more than respective reference boundary values, the situation determination unit 70 may determine that the vehicle is in an abnormal state, and thus may not estimate the damper speeds of the front and rear wheel suspensions.

Here, the reference boundary values are values which are predetermined to determine whether or not the roll rate and the pitch rate detected by the sensor units 10 are abnormal, and if the roll rate and the pitch rate are the respective reference boundary values or more, the situation determination unit 70 may determine that the vehicle is in the abnormal state, and may not perform determination of the damper speeds of the front and rear wheel suspensions. In addition, the situation determination unit 70 may turn on a warning message to inform a driver of the abnormal state of the vehicle.

Accordingly, the situation determination unit 70 may detect the non-steering situation of the vehicle by determining information about the driving speed, the steering angle, the roll rate and the pitch rate, and estimates damper speeds of the front and rear wheel suspensions in a straight driving situation of the vehicle due to the non-steering situation of the vehicle.

In an exemplary embodiment of the present invention, the sensor units 10 may be body G sensors installed at three sections of the four sections of the vehicle body provided with the wheels, and the estimation unit 20 may estimate the vertical accelerations of the vehicle body above the wheels through the body G sensors.

Although FIG. 2 illustrates each sensor unit 10 as being installed at all of the four sections of a vehicle body 80 provided with wheels, each sensor unit 10 may be installed at only three sections of the vehicle body 80. Although the detailed description below will be made, based on the vertical accelerations of the vehicle body above the wheels measured through the sensor units 10 installed at the three sections out of the four sections of the vehicle body 80, vertical accelerations and vertical speeds of the vehicle body 80 above the wheels in the four sections may be estimated. The sensor units 10 may be configured such that a front left sensor unit 11 and a front right sensor unit 12 are installed at both sides of the front portion of the vehicle body 80, and one of a rear left sensor 13 and a rear right sensor 14 is installed at a corresponding one of both sides of the rear portion of the vehicle body 80. However, the present invention is not limited thereto, and the rear left sensor 13 and the rear right sensor 14 may be installed at both sides of the rear portion of the vehicle body 80, and one of the front left sensor unit 11 and the front right sensor unit 12 may be installed at a corresponding one of both sides of the front portion of the vehicle body 80.

Hereinafter, in order to assist understanding of the present invention, the case in which the rear right sensor 14 is omitted will be described below.

Specifically, the estimation unit 20 may receive the vertical accelerations of the three sections among the four sections of the vehicle body 80 above the wheels, measured through the body G sensors, derive a vertical speed of a center of mass of the vehicle body 80 using the vertical accelerations of the three sections of the vehicle body 80 above the wheels, and determine a vertical speed of the remaining one section among the four sections of the vehicle body 80 using the vertical speed of the center of mass of the vehicle body 80, the roll rate and the pitch rate.

Here, as described above, the vertical accelerations of the three sections selected from the four sections of the vehicle body 80 above the wheels may be measured through the body G sensors installed at the three sections, vertical speeds may be determined by integrating the measured vertical accelerations of the three sections of the vehicle body 80, and then final vertical speeds may be acquired by passing the determined vertical speeds through a high-pass filter to remove errors.

That is, in order to determine the vertical speed of the section of the vehicle body 80 provided with no sensor unit 10, among the four sections of the vehicle body 80, the estimation unit 20 may determine the vertical speed of the center of mass of the vehicle body 80 using the following Equations which use the vertical accelerations of the three sections of the vehicle body 80 above the wheels.

Here, the following Equations are derived based on a vehicle model, which is constructed based on a pitch direction, a roll direction and a heave direction, shown in FIG. 2, and a suspension force model shown in FIG. 4.

v_{bz FL}=v_{cz est}+t1·\dot{φ}−a·\dot{ϕ}

v_{bz_FR}=v_{cz_est}−t1·\dot{φ}−a·\dot{ϕ}

v_{bz_RL}=v_{cz_est}+t2·\dot{φ}+b·\dot{ϕ}

v_{cz_est}=0.5·(v_{bz_FL}+v_{bz_FR}+2·a·\dot{ϕ})

Here, v_{bz_FL} is the vertical speed [m/s] of the vehicle body above the front left wheel, v_{bz_FR} is the vertical speed [m/s] of the vehicle body above the front right wheel, v_{bz_RL} is the vertical speed [m/s] of the vehicle body above the rear left wheel, v_{cz_est} is the vertical speed [m/s] of the center of mass of the vehicle body, t1 is a front wheel tread [m], t2 is a rear wheel tread [m], a is a distance [m] from the center of mass of the vehicle body to a front shaft, b is a distance [m] from the center of mass of the vehicle body to a rear shaft, ϕ is a roll angle [rad], and φ is a pitch angle [rad].

Here, the estimation unit 20 may determine a roll rate and a pitch rate based on the vertical accelerations of the three sections of the vehicle body using the following Equations.

$$\dot{ϕ} = - 0.5 / t 1 \cdot ( {v}_{bz\_FL} - {v}_{bz\_FR} ) \dot{ϕ} = - 0.5 / t 1 \cdot ( {v}_{bz\_FL} - {v}_{bz\_FR} )$$

$$\dot{φ} = 0.5 / ( a + b ) \cdot {( {v}_{bz\_FL} + {v}_{bz\_FR} )}^{- t 2} \cdot 0.5 / ( t 1 \cdot ( a + b ) ) \cdot ( {v}_{bz\_FL} - {v}_{bz\_FR} ) + 1 / ( a + b ) \cdot {v}_{bz\_RL}$$

Thereby, the estimation unit 20 may determine the vertical speed of the center of mass of the vehicle body, the roll rate and the pitch rate, and determine the vertical speed of the remaining one section among the four sections of the vehicle body using the following Equation.

v_{bz_RR}=v_{cz_est}−t2·\dot{φ}+b·\dot{ϕ}

Here, v_{cz_RR} is the vertical speed [m/s] of the vehicle body above the rear right wheel.

Accordingly, the vertical speed of the remaining one section among the four sections of the vehicle body above the respective wheels is derived through the body G sensors installed at the three sections among the four sections of the vehicle body, and thus the vertical speeds of all of the sections of the vehicle body may be derived.

Furthermore, the sensor unit 10 may include a 6D sensor, the 6D sensor may measure a vertical acceleration of the center of mass of the vehicle body, a roll rate and a pitch rate, and the estimation unit 20 may derive vertical speeds of the vehicle bodies above the respective wheels using the vertical acceleration of the center of mass of the vehicle body, the roll rate and the pitch rate. Here, the 6D sensor may basically output the roll rate and the pitch rate due to the nature thereof, thus being configured for deriving the vertical speeds of the above-described sections of the vehicle body.

Here, Equations to determine the vertical speeds of the vehicle body above the respective wheels through the 6D sensor are the same as the above-described Equations to determine the vertical speeds of the vehicle body above the wheels through the body G sensors, and are shown as below.

v_{bz_FL}=v_{cz_est}+t1·\dot{φ}−a·\dot{ϕ}

v_{bz_FR}=v_{cz_est}−t1·\dot{φ}−a·\dot{ϕ}

v_{bz RL}=v_{cz est}+t2·\dot{φ}+b·\dot{ϕ}

v_{bz_RR}=v_{cz_est}−t2·\dot{φ}+b·\dot{ϕ}

Accordingly, when the vertical speeds of all of the sections of the vehicle body above the wheels are determined, relative vertical speeds of the respective front wheels with respect to the vertical speeds of the vehicle body above the wheels are determined.

For this purpose, the derivation unit 30 may derive vertical accelerations of the vehicle body above the respective rear wheels by integrating the vertical speeds of the vehicle body above the rear wheels, and derive forces acting on the regions above the respective rear wheels using the vertical accelerations of the vehicle body above the rear wheels. Here, although forces acting on the regions above the respective front wheels may first be derived and then the forces acting on the regions above the respective rear wheels may be derived by reversing a determination process of the forces acting on the regions above the respective front wheels, errors may be reduced based only on the vertical speeds of the vehicle body above the rear wheels due to characteristics of the vehicle, and particularly, the determination process in accordance with various aspects of the present invention is performed in the straight driving situation of the vehicle, and thus, the forces acting on the regions above the respective rear wheels may be derived in consideration of the pitch rate, the roll rate and the vertical accelerations of the vehicle body.

Specifically, the first calculation unit 40 may derive the forces acting on the regions above the respective rear wheels using the vertical speeds of the vehicle body, which are derived through the estimation unit 20. In more detail, the first calculation unit 40 may determine force acting on a rear left suspension and force acting on a rear right suspension using the following Equations.

$${F}_{z\_RL} = {a}_{bz\_RL} \cdot \frac{{m}_{s}}{4}$$

$${F}_{z\_RR} = {a}_{bz\_RR} \cdot \frac{{m}_{s}}{4}$$

Here, F_{z_RL} is the force (N) acting on the rear left suspension, F_{z_RR} is the force (N) acting on the rear right suspension, a_{bz_RL} is the vertical acceleration of the vehicle body above the rear left wheel, a_{bz_RR} is the vertical acceleration of the vehicle body above the rear right wheel, and mₛ is a sprung mass (kg).

The forces acting on the regions above the respective rear wheels may be derived based on the vehicle model, which is constructed based on the pitch direction, the roll direction and the heave direction, shown in FIG. 2, the vertical acceleration of the vehicle body above the rear left wheel and the vertical acceleration of the vehicle body above the rear right wheel may be derived by integrating the above-described vertical speed of the vehicle body above the rear left wheel and vertical speed of the vehicle body above the rear right wheel, and the forces acting on the regions above the respective rear wheels corresponding to the rear suspensions out of the four corners of the vehicle body may be derived.

That is, the Equations a_{bz_RL}=a_{cz_est}+t2·\ddot{φ}+b·\ddot{ϕ} and a_{bz_RR}=a_{cz_est}−t2·\ddot{φ}+b·\ddot{ϕ} may be derived by integrating the Equations v_{bz_RL}=v_{cz_est}+t2·\dot{φ}+b·\dot{ϕ} and v_{bz_RR}=v_{cz_est}−t2·\dot{φ}+b·\dot{ϕ}, and the forces acting on the regions above the respective rear wheels may be derived using the above-described Equations pertaining to the force acting on the region above the rear left wheel and the force acting on the region above the rear right wheel.

When the forces acting on the regions above the respective rear wheels are derived, the first calculation unit 40 derives forces acting on the regions above the respective front wheels depending on a situation in which the roll rate and the pitch rate occur, using the forces acting on the regions above the respective rear wheels, and determines relative vertical speeds of the respective front wheels with respect to the vertical speeds of the vehicle body above the respective front wheels using the forces acting on the regions above the respective front wheels. That is, if relative vertical speeds of the dampers of the left and right wheel suspensions are different, the roll rate and the pitch rate are present, and thus, the first calculation unit 40 determines the forces acting on the regions above the respective front wheels depending on the situation in which the roll rate and the pitch rate occur, using the forces acting on the regions above the respective rear wheels.

For the present purpose, the forces acting on the regions above the respective front wheels, determined by the derivation unit 30, and the relative vertical speeds of the respective front wheels with respect to the vertical speeds of the vehicle body above the respective front wheels, determined by the first calculation unit 40, may be determined using the following Equations. These Equations are based on a vehicle model, which is constructed based on a pitch direction and a roll direction, as shown in FIG. 3.

Roll Rate Equation:

Iₓ·\ddot{φ}=t1·(F_{z FL}−F_{z FR})+t2·(F_{z RL}−F_{z RR})

Pitch Rate Equation:

$${I}_{v} \cdot \ddot{θ} = - a \cdot ( {F}_{z\_FL} + {F}_{z\_FR} ) + b \cdot ( {F}_{z\_RL} + {F}_{z\_RR} )$$

$${F}_{z\_FL} = ( {I}_{x} \cdot \ddot{ϕ} - t 2 \cdot ( {F}_{z\_RL} - {F}_{z\_RR} ) ) / t 1 + {F}_{z\_FR}$$

$${F}_{z\_FL} = ( {I}_{x} \cdot \ddot{ϕ} - t 2 \cdot ( {F}_{z\_RL} - {F}_{z\_RR} ) ) / t 1 + {F}_{z\_FR}$$

$${F}_{z\_FR} = \frac{( {-}^{( {I}_{y} \cdot θ - b \cdot ( {F}_{z\_RL} - {F}_{z\_RR} ) )} / {a}^{- ( {I}_{x} \cdot \ddot{ϕ} - t 2 \cdot ( {F}_{z\_RL} - {F}_{z\_RR} ) )} / t 1 )}{2}$$

$${F}_{z\_FR} = \frac{( {-}^{( {I}_{y} \cdot θ - b \cdot ( {F}_{z\_RL} - {F}_{z\_RR} ) )} / {a}^{- ( {I}_{x} \cdot \ddot{ϕ} - t 2 \cdot ( {F}_{z\_RL} - {F}_{z\_RR} ) )} / t 1 )}{2}$$

Here, Iₓ is roll inertia (kgm\hat{ }2), I_{y} is pitch inertia (kgm\hat{ }2), F_{z_RL} is the force (N) acting on the rear left suspension, and F_{z_RR} is the force (N) acting on the rear right suspension.

That is, the relative vertical speeds of the respective front wheels with respect to the vertical speeds of the vehicle body above the respective front wheels are determined through the vehicle model which behaves in the pitch direction and the roll direction, the force acting on the region above the front left wheel and the force acting on the region above the front right wheel are derived based on the roll rate Equation and the pitch rate Equation depending on the situation in which the roll rate and the pitch rate occur, and the relative vertical speeds of the front left wheel and the relative vertical speed of the front right wheel are derived using the forces acting on the regions above the respective front wheels.

That is, the first calculation unit 40 may determine the relative vertical speeds of the respective front wheels with respect to the vertical speeds of the vehicle body above the respective front wheels using the following Equations.

$$Δ {\dot{x}}_{FL} = ( {F}_{zFL} - {k}_{FL} \cdot Δ {x}_{FL} ) / {b}_{FL} Δ {\dot{x}}_{FL} = ( {F}_{zFL} - {k}_{FL} \cdot Δ {x}_{FL} ) / {b}_{FL}$$

$$Δ {\dot{x}}_{FL} = ( {F}_{zFL} - {k}_{FL} \cdot Δ {x}_{FL} ) / {b}_{FL}$$

$$Δ {\dot{x}}_{FR} = ( {F}_{zFR} - {k}_{FR} \cdot Δ {x}_{FR} ) / {b}_{FR} Δ {\dot{x}}_{FR} = ( {F}_{zFR} - {k}_{FR} \cdot Δ {x}_{FR} ) / {b}_{FR}$$

Here, Δ\dot{x}_{FL} is the relative vertical speed (m/s) of the front left wheel, Δ\dot{x}_{FR} is the relative vertical speed (m/s) of the front right wheel, k_{FL} is spring rigidity (N/m) of the front left suspension, k_{FR} is spring rigidity (N/m) of the front right suspension, b_{FL} is a front left damping coefficient (Ns/m), and b_{FR} is a front right damping coefficient (Ns/m).

These Equations are derived based on the following Equations.

F_{z_FL}=k_{FL}·Δx_{FL}+b_{FL}·Δ\dot{x}_{FL}

F_{z_FR}=k_{FR}·Δx_{FR}+b_{FR}·Δ\dot{x}_{FR}

These Equations are based on the vehicle model shown in FIG. 4, k_{FL}·Δx_{FL} is spring force, b_{FL}·Δ\dot{x}_{FL} is damper force, and the forces acting on the regions above the wheels are derived through the Equations.

As described above, under the condition that the vehicle is driven straight in the non-steering situation, the relative vertical speeds of the respective front wheels may be derived based on the vehicle model which is constructed based on the roll direction, the pitch direction and the heave direction.

Thereafter, the second calculation unit 50 may determine vertical speeds of the respective front wheels using the relative vertical speeds of the respective front wheels, derive a delay caused by a wheelbase between the front and rear wheels and a vehicle speed, derive vertical speeds of the respective rear wheels after the delay compared to the vertical speeds of the respective front wheels, and determine relative vertical speeds of the respective rear wheels with respect to the vertical speeds of the vehicle body above the respective rear wheels using the vertical speeds of the respective rear wheels.

That is, since the vehicle is driven straight in the non-steering situation, the speed of the front wheels and the speed of the rear wheels are similar, but a difference between the speed of the front wheels and the speed of the rear wheels may occur caused by the wheelbase of the vehicle and the vehicle speed. Therefore, a delay time, after which the rear wheels pass through a position through which the front wheels have passed, is incurred.

In view thereof, the vertical speeds of the respective rear wheels may be estimated, and the relative vertical speeds of the respective rear wheels with respect to the vertical speeds of the vehicle body above the respective rear wheels may be determined.

For this purpose, the second calculation unit 50 may derive the vertical speeds of the respective rear wheels after the delay, and determine the relative vertical speeds of the respective rear wheels with respect to the vertical speeds of the vehicle body above the respective rear wheels, using the following Equations.

$$delay = \frac{a + b}{{υ}_{x}} delay = \frac{a + b}{{υ}_{x}}$$

$${\dot{x}}_{usFL} = Δ {\dot{x}}_{FL} + {\dot{x}}_{sFL} {\dot{x}}_{usFL} = Δ {\dot{x}}_{FL} + {\dot{x}}_{sFL}$$

$${\dot{x}}_{usFR} = Δ {\dot{x}}_{FR} + {\dot{x}}_{sFR} {\dot{x}}_{usFR} = Δ {\dot{x}}_{FR} + {\dot{x}}_{sFR}$$

$${\dot{x}}_{us\_RL} = \frac{a + b}{{υ}_{x}} ( {\dot{x}}_{us\_FL} ) = {\dot{x}}_{ux\_FL} {\dot{x}}_{us\_RL} = \frac{a + b}{{υ}_{x}} ( {\dot{x}}_{us\_FL} ) = {\dot{x}}_{ux\_FL}$$

$${\dot{x}}_{us\_RR} = \frac{a + b}{{υ}_{x}} ( {\dot{x}}_{us\_FR} ) = {\dot{x}}_{ux\_FR}$$

$${\dot{x}}_{us\_RR} = \frac{a + b}{{υ}_{x}} ( {\dot{x}}_{us\_FR} ) = {\dot{x}}_{ux\_FR}$$

$$Δ {\dot{x}}_{RL} = {\dot{x}}_{us\_RL} - {\dot{x}}_{s\_RL}$$

$$Δ {\dot{x}}_{RR} = {\dot{x}}_{us\_RR} - {\dot{x}}_{s\_RR}$$

Here, \dot{x}_{us_FL} is the vertical speed (m/s) of the front left wheel, \dot{x}_{us_FR} is the vertical speed (m/s) of the front right wheel, \dot{x}_{us_RL} is the vertical speed (m/s) of the rear left wheel, \dot{x}_{us_RR} is a vertical speed (m/s) of the rear right wheel, Δ\dot{x}_{RL} is the relative vertical speed (m/s) of the rear left wheel, and Δ\dot{x}_{RR} is the relative vertical speed (m/s) of the rear right wheel.

Accordingly, the delay may be derived by dividing the wheelbase, i.e., the sum of the distance a from the center of mass of the vehicle body to the front shaft and the distance b from the center of mass of the vehicle body to the rear shaft, by the driving speed.

Furthermore, in order to describe the vertical speeds of the vehicle body above the respective wheels, the vertical speed of the vehicle body above the front left wheel may be exemplarily derived using a force equilibrium equation Δx_{FL}=x_{usFL}−x_{sFL} based on the vehicle model shown in FIG. 3. Here, Δx_{FL} is a distance between the vehicle body and the front left wheel, x_{usFL} is a position of the center of the front left wheel, and x_{sFL} is a position of the center of a quarter of the vehicle body located above the front left wheel.

When the relative vertical speeds of all of the wheels have been derived, the controller 60 may control the dampers of the front wheel suspensions and the rear wheel suspensions at the relative vertical speeds corresponding to the respective wheels, thus being configured for effectively controlling the electronically controlled suspension (ECS). Thereby, the speeds of the suspension dampers optimized for ECS control may be derived, and wheel G sensors may be omitted through derivation of the above-described speeds of the dampers, thus being configured for reducing material costs.

A damper control method for vehicles in accordance with various aspects of the present invention includes, as exemplarily shown in FIG. 5 and FIG. 6, measuring vertical accelerations of a vehicle body above respective wheels through the sensor units 10 (Operation S10), estimating vertical speeds of the vehicle body above the respective wheels using the vertical accelerations of the vehicle body (Operation S20), deriving forces acting on the regions above respective front wheels using the vertical speeds of the vehicle body derived through the estimation, i.e., Operation S20, (Operation S30), primarily determining relative vertical speeds of the respective front wheels with respect to the vertical speeds of the vehicle body above the respective front wheels using the forces acting on the regions above the respective front wheels and determining vertical speeds of the respective front wheels using the relative vertical speeds of the respective front wheels (Operation S40), estimating vertical speeds of respective rear wheels of the respective wheels after a delay of a specific time using the vertical speeds of the respective front wheels determined through Operation S40 and secondarily determining relative vertical speeds of the respective rear wheels with respect to the vertical speeds of the vehicle body above the respective rear wheels (Operation S50), and controlling dampers of front wheel suspensions and rear wheel suspensions using the relative vertical speeds of the respective wheels derived in Operation S40 and Operation S50 (Operation S60).

Here, the damper control method for vehicles in accordance with various aspects of the present invention further includes receiving steering information about a steering angle or a steering angular speed and comparing the steering angle or the steering angular speed with a predetermined reference steering value (Operation S70), and in Operation S70, if the steering angle or the steering angular speed is equal to or less than the predetermined reference steering value, the vehicle may be determined to be in a non-steering situation and thus the speeds of the dampers of the front and rear wheel suspensions may be estimated.

In addition, in Operation S70, driving speed information of the vehicle is further received, if the driving speed is equal to or more than a predetermined reference speed value, whether or not the vehicle is in the non-steering situation is determined, and if a roll rate and a pitch rate measured through the sensor units 10 are equal to or more than respective reference boundary values, it is determined that the vehicle is in an abnormal state and thus the speeds of the dampers of the front and rear wheel suspensions are not estimated.

In the measurement (Operation S10), the sensor unit 10 includes a 6D sensor or a body G sensor, if the sensor unit 10 includes the 6D sensor, the 6D sensor may measure a vertical acceleration of a center of mass of the vehicle body, the roll rate and the pitch rate, and if the sensor unit 10 includes the body G sensor, the body G sensor may be installed at each of three sections among a total of four sections of the vehicle body provided with the wheels and the estimation unit 20 may estimate the vertical accelerations of the vehicle body above the wheels by receiving information about the vertical acceleration of the center of mass of the vehicle body, the roll rate and the pitch rate through the sensor units 10.

That is, if the sensor unit 10 includes the body G sensor, in the estimation (Operation S20), the vertical accelerations of the three sections among the four sections of the vehicle body 80 above the wheels, measured through the sensor units 10, may be received, the vertical speed of the center of mass of the vehicle body may be derived using the vertical accelerations of the three sections of the vehicle body above the wheels, and the vertical speed of the remaining one section among the four sections of the vehicle body above the respective wheels may be determined using the vertical speed of the center of mass of the vehicle body, the roll rate and the pitch rate.

Specifically, in the estimation (Operation S20), the vertical speed of the center of mass of the vehicle body may be determined using the following Equations.

v_{bz_FL}=v_{cz_est}+t1·\dot{φ}−a·\dot{ϕ}

v_{bz_FR}=v_{cz_est}−t1·\dot{φ}−a·\dot{ϕ}

v_{bz_RL}=v_{cz_est}+t2·\dot{φ}+b·\dot{ϕ}

v_{cz_est}=0.5·(v_{bz_FL}+v_{bz_FR}+2·a·\dot{ϕ})

Here, v_{bz_FL} is the vertical speed [m/s] of the vehicle body above the front left wheel, v_{bz_FR} is the vertical speed [m/s] of the vehicle body above the front right wheel, v_{bz_RL} is the vertical speed [m/s] of the vehicle body above the rear left wheel, v_{cz_est} is the vertical speed [m/s] of the center of mass of the vehicle body, t1 is a front wheel tread [m], t2 is a rear wheel tread [m], a is a distance [m] from the center of mass of the vehicle body to a front shaft, b is a distance [m] from the center of mass of the vehicle body to a rear shaft, ϕ is a roll angle [rad], and φ is a pitch angle [rad].

Furthermore, in the estimation (Operation S20), the roll rate and the pitch rate may be determined using the following Equations.

$$\dot{ϕ} = - 0.5 / t 1 \cdot ( {v}_{bz\_FL} - {v}_{bz\_FR} ) \dot{ϕ} = - 0.5 / t 1 \cdot ( {v}_{bz\_FL} - {v}_{bz\_FR} )$$

$$\dot{φ} = 0.5 / ( a + b ) \cdot {( {v}_{bz\_FL} + {v}_{bz\_FR} )}^{- t 2} \cdot 0.5 / ( t 1 \cdot ( a + b ) ) \cdot ( {v}_{bz\_FL} - {v}_{bz\_FR} ) + 1 / ( a + b ) \cdot {v}_{bz\_RL}$$

Furthermore, in the estimation (Operation S20), the vertical speed of the remaining one section among the four sections of the vehicle body above the respective wheels may be determined using the following Equation.

v_{bz_RR}=v_{cz_est}−t2·\dot{φ}+b·\dot{ϕ}

Here, v_{cz_RR} is the vertical speed [m/s] of the vehicle body above the rear right wheel.

In the derivation (Operation S30), vertical accelerations of the vehicle body above the respective rear wheels may be derived by integrating the vertical speeds of the vehicle body above the rear wheels, and forces acting on the regions above the respective rear wheels may be derived using the vertical accelerations of the vehicle body above the rear wheels.

In more detail, force acting on the rear left suspension and force acting on the rear right suspension may be determined using the following Equations.

$${F}_{z\_RL} = {a}_{bz\_RL} \cdot \frac{{m}_{s}}{4}$$

$${F}_{z\_RR} = {a}_{bz\_RR} \cdot \frac{{m}_{s}}{4}$$

Here, F_{z_RL} is the force (N) acting on the rear left suspension, F_{z_RR} is the force (N) acting on the rear right suspension, a_{bz_RL} is the vertical acceleration of the vehicle body above the rear left wheel, a_{bz_RR} is the vertical acceleration of the vehicle body above the rear right wheel, and mₛ is a sprung mass (kg).

In the primary determination (Operation S40), the forces acting on the regions above the respective front wheels depending on the situation in which the roll rate and the pitch rate occur may be derived, and relative vertical speeds of the respective front wheels with respect to the vertical speeds of the vehicle body above the respective front wheels may be determined using the forces acting on the regions above the respective front wheels.

Concretely, in the primary determination (Operation S40), the forces acting on the regions above the respective front wheels depending on the roll rate and the pitch rate may be determined using the following Equations.

Roll Rate Equation:

Iₓ·\ddot{φ}=t1·(F_{z_FL}−F_{z_FR})+t2·(F_{z_RL}−F_{z_RR})

Pitch Rate Equation:

$${I}_{v} \cdot \ddot{θ} = - a \cdot ( {F}_{z\_FL} + {F}_{z\_FR} ) + b \cdot ( {F}_{z\_RL} + {F}_{z\_RR} )$$

$${F}_{z\_FL} = ( {I}_{x} \cdot \ddot{ϕ} - t 2 \cdot ( {F}_{z\_RL} - {F}_{z\_RR} ) ) / t 1 + {F}_{z\_FR}$$

$${F}_{z\_FL} = ( {I}_{x} \cdot \ddot{ϕ} - t 2 \cdot ( {F}_{z\_RL} - {F}_{z\_RR} ) ) / t 1 + {F}_{z\_FR}$$

$${F}_{z\_FR} = \frac{( {-}^{( {I}_{y} \cdot θ - b \cdot ( {F}_{z\_RL} - {F}_{z\_RR} ) )} / {a}^{- ( {I}_{x} \cdot \ddot{ϕ} - t 2 \cdot ( {F}_{z\_RL} - {F}_{z\_RR} ) )} / t 1 )}{2}$$

$${F}_{z\_FR} = \frac{( {-}^{( {I}_{y} \cdot θ - b \cdot ( {F}_{z\_RL} - {F}_{z\_RR} ) )} / {a}^{- ( {I}_{x} \cdot \ddot{ϕ} - t 2 \cdot ( {F}_{z\_RL} - {F}_{z\_RR} ) )} / t 1 )}{2} .$$

Here, Iₓ is roll inertia (kgm\hat{ }2), I_{y} is pitch inertia (kgm\hat{ }2), F_{z_RL} is the force (N) acting on the rear left suspension, and F_{z_RR} is the force (N) acting on the rear right suspension.

Furthermore, in the primary determination (Operation S40), the relative vertical speeds of the respective front wheels with respect to the vertical speeds of the vehicle body above the respective front wheels may be determined using the following Equations.

$$Δ {\dot{x}}_{FL} = ( {F}_{zFL} - {k}_{FL} \cdot Δ {x}_{FL} ) / {b}_{FL} Δ {\dot{x}}_{FL} = ( {F}_{zFL} - {k}_{FL} \cdot Δ {x}_{FL} ) / {b}_{FL}$$

$$Δ {\dot{x}}_{FL} = ( {F}_{zFL} - {k}_{FL} \cdot Δ {x}_{FL} ) / {b}_{FL}$$

$$Δ {\dot{x}}_{FR} = ( {F}_{zFR} - {k}_{FR} \cdot Δ {x}_{FR} ) / {b}_{FR} Δ {\dot{x}}_{FR} = ( {F}_{zFR} - {k}_{FR} \cdot Δ {x}_{FR} ) / {b}_{FR}$$

Here, Δ\dot{x}_{FL} is the relative vertical speed (m/s) of the front left wheel, Δ\dot{x}_{FR} is the relative vertical speed (m/s) of the front right wheel, k_{FL} is spring rigidity (N/m) of the front left suspension, k_{FR} is spring rigidity (N/m) of the front right suspension, b_{FL} is a front left damping coefficient (Ns/m), and b_{FR} is a front right damping coefficient (Ns/m).

In the estimation and the secondary determination (Operation S50), the vertical speeds of the respective front wheels may be determined using the relative vertical speeds of the respective front wheels, a delay caused by a wheelbase between the front and rear wheels and a vehicle speed may be derived, the vertical speeds of the respective rear wheels after the delay compared to the vertical speeds of the respective front wheels may be derived, and the relative vertical speeds of the respective rear wheels with respect to the vertical speeds of the vehicle body above the respective rear wheels may be determined using the vertical speeds of the respective rear wheels.

That is, in the estimation and the secondary determination (Operation S50), the vertical speeds of the respective rear wheels after the delay may be derived, and the relative vertical speeds of the respective rear wheels with respect to the vertical speeds of the vehicle body above the respective rear wheels may be determined, using the following Equations.

$$delay = \frac{a + b}{{υ}_{x}} delay = \frac{a + b}{{υ}_{x}}$$

$${\dot{x}}_{usFL} = Δ {\dot{x}}_{FL} + {\dot{x}}_{sFL}$$

$${\dot{x}}_{usFR} = Δ {\dot{x}}_{FR} + {\dot{x}}_{sFR}$$

$${\dot{x}}_{us\_RL} = \frac{a + b}{{υ}_{x}} ( {\dot{x}}_{us\_FL} ) = {\dot{x}}_{ux\_FL} {\dot{x}}_{us\_RL} = \frac{a + b}{{υ}_{x}} ( {\dot{x}}_{us\_FL} ) = {\dot{x}}_{ux\_FL}$$

$${\dot{x}}_{us\_RR} = \frac{a + b}{{υ}_{x}} ( {\dot{x}}_{us\_FR} ) = {\dot{x}}_{ux\_FR} {\dot{x}}_{us\_RR} = \frac{a + b}{{υ}_{x}} ( {\dot{x}}_{us\_FL} ) = {\dot{x}}_{us\_FR}$$

$$Δ {\dot{x}}_{RL} = {\dot{x}}_{us\_RL} - {\dot{x}}_{s\_RL}$$

$$Δ {\dot{x}}_{RR} = {\dot{x}}_{us\_RR} - {\dot{x}}_{s\_RR}$$

Here, \dot{x}_{us_FL} is the vertical speed (m/s) of the front left wheel, \dot{x}_{us_FR} is the vertical speed (m/s) of the front right wheel, \dot{x}_{us_RL} is the vertical speed (m/s) of the rear left wheel, \dot{x}_{us_RR} is the vertical speed (m/s) of the rear right wheel, Δ\dot{x}_{RL} is the relative vertical speed (m/s) of the rear left wheel, and Δ\dot{x}_{RR} is the relative vertical speed (m/s) of the rear right wheel.

When the relative vertical speeds of all of the wheels have been derived, the dampers of the front wheel suspensions and the rear wheel suspensions are controlled at the relative vertical speeds corresponding to the respective wheels, and thus the electronically controlled suspension (ECS) may be effectively controlled. Thereby, the speeds of the suspension dampers optimized for ECS control may be derived, and wheel G sensors may be omitted and thus material costs may be reduced through derivation of the above-described speeds of the dampers.

As is apparent from the above description, a damper control system and method having the above-described structure in accordance with various aspects of the present invention may reduce the number of sensor units and effectively control dampers compared to conventional systems and methods.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described in order to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A damper control system for vehicle, the system comprising:
an estimation unit configured to receive vertical accelerations of a vehicle body above respective wheels of the vehicle, measured through sensors, and to estimate vertical speeds of the vehicle body above the respective wheels using the vertical accelerations of the vehicle body;
a derivation unit configured to derive forces acting on regions above respective front wheels of the respective wheels using the vertical speeds of the vehicle body derived through the estimation unit;
a first calculation unit configured to determine relative vertical speeds of the respective front wheels with respect to the vertical speeds of the vehicle body above the respective front wheels using the forces acting on the regions above the respective front wheels, and to determine vertical speeds of the respective front wheels using the relative vertical speeds of the respective front wheels;
a second calculation unit configured to estimate vertical speeds of respective rear wheels of the respective wheels after a delay of a predetermined time using the vertical speeds of the respective front wheels determined by the first calculation unit, and to determine relative vertical speeds of the respective rear wheels with respect to the vertical speeds of the vehicle body above the respective rear wheels; and
a controller configured to control dampers of front wheel suspensions and rear wheel suspensions using the relative vertical speeds of the respective wheels derived by the first calculation unit and the second calculation unit.

2. The damper control system for the vehicle according to claim 1, further including a situation determination unit configured to receive steering information about a steering angle or a steering angular speed and to compare the steering angle or the steering angular speed with a predetermined reference steering value,
wherein, when the steering angle or the steering angular speed is equal to or less than the predetermined reference steering value, the situation determination unit is configured to determine that the vehicle is in a non-steering situation and estimates speeds of the dampers of the front and rear wheel suspensions.

3. The damper control system for the vehicle according to claim 2, wherein the situation determination unit further receives driving speed information of the vehicle, and determines whether the vehicle is in the non-steering situation, when a driving speed of the vehicle is equal to or more than a predetermined reference speed value.

4. The damper control system for the vehicle according to claim 2, wherein, when a roll rate and a pitch rate measured through the sensors are equal to or more than respective reference boundary values, the situation determination unit is configured to determine that the vehicle is in an abnormal state and does not estimate the speeds of the dampers of the front and rear wheel suspensions.

5. The damper control system for the vehicle according to claim 1, wherein the sensors include a 6D sensor, and the 6D sensor measures a vertical acceleration of a center of mass of the vehicle body, a roll rate and a pitch rate, and
wherein the estimation unit derives the vertical speeds of the vehicle body above the respective wheels using the vertical acceleration of the center of mass of the vehicle body, the roll rate and the pitch rate.

6. The damper control system for the vehicle according to claim 1,
wherein the sensors include a body G sensor mounted at each of three sections among a total of four sections of the vehicle body provided with the respective wheels, and the estimation unit estimates the vertical accelerations of the vehicle body above the respective wheels through the body G sensors.

7. The damper control system for the vehicle according to claim 6,
wherein the estimation unit receives the vertical accelerations of the three sections among the four sections of the vehicle body above the respective wheels, measured through the body G sensors, derives a vertical speed of a center of mass of the vehicle body using the vertical accelerations of the three sections of the vehicle body above the respective wheels, and determines a vertical speed of a remaining one section among the four sections of the vehicle body above the respective wheels using the vertical speed of the center of mass of the vehicle body, a roll rate and a pitch rate.

8. The damper control system for the vehicle according to claim 7,
wherein the derivation unit derives the vertical accelerations of the vehicle body above the respective rear wheels by integrating the vertical speeds of the vehicle body above the respective rear wheels, and derives forces acting on regions above the respective rear wheels using the vertical accelerations of the vehicle body above the rear wheels.

9. The damper control system for the vehicle according to claim 8,
wherein the first calculation unit derives the forces acting on the regions above the respective front wheels depending on a situation in which the roll rate and the pitch rate occur, and determines the relative vertical speeds of the respective front wheels with respect to the vertical speeds of the vehicle body above the respective front wheels using the forces acting on the regions above the respective front wheels.

10. The damper control system for the vehicle according to claim 9,
wherein the second calculation unit is configured to determine the vertical speeds of the respective front wheels using the relative vertical speeds of the respective front wheels, derives a delay caused by a wheelbase between the front and rear wheels and a vehicle speed, derives the vertical speeds of the respective rear wheels after the delay compared to the vertical speeds of the respective front wheels, and is configured to determine the relative vertical speeds of the respective rear wheels with respect to the vertical speeds of the vehicle body above the respective rear wheels using the vertical speeds of the respective rear wheels.

11. A damper control method for vehicle, the method comprising:
measuring vertical accelerations of a vehicle body above respective wheels through sensors;
estimating vertical speeds of the vehicle body above the respective wheels using the vertical accelerations of the vehicle body;
deriving forces acting on regions above respective front wheels of the respective wheels using the vertical speeds of the vehicle body derived through the estimating;
primarily determining relative vertical speeds of the respective front wheels with respect to the vertical speeds of the vehicle body above the respective front wheels using the forces acting on the regions above the respective front wheels, and determining vertical speeds of the respective front wheels using the relative vertical speeds of the respective front wheels;
estimating vertical speeds of respective rear wheels of the respective wheels after a delay of a predetermined time using the vertical speeds of the respective front wheels determined through the primarily determining, and secondarily determining relative vertical speeds of the respective rear wheels with respect to the vertical speeds of the vehicle body above the respective rear wheels; and
controlling dampers of front wheel suspensions and rear wheel suspensions using the relative vertical speeds of the respective wheels derived in the primarily determining and the estimating and secondarily determining.

12. The damper control method for the vehicle according to claim 11, further including receiving steering information about a steering angle or a steering angular speed and comparing the steering angle or the steering angular speed with a predetermined reference steering value,
wherein, in the receiving the steering information and the comparing the steering angle or the steering angular speed with the predetermined reference steering value, when the steering angle or the steering angular speed is equal to or less than the predetermined reference steering value, the vehicle is determined to be in a non-steering situation and speeds of the dampers of the front and rear wheel suspensions are estimated.

13. The damper control method for the vehicle according to claim 12,
wherein, in the receiving the steering information and the comparing the steering angle or the steering angular speed with the predetermined reference steering value, driving speed information of the vehicle is further received, and when a driving speed of the vehicle is equal to or more than a predetermined reference speed value, whether the vehicle is in the non-steering situation is determined; and
when a roll rate and a pitch rate measured through the sensors are equal to or more than respective reference boundary values, the vehicle is determined to be in an abnormal state and the speeds of the dampers of the front and rear wheel suspensions are not estimated.

14. The damper control method for the vehicle according to claim 11,
wherein, in the measuring the vertical accelerations of the vehicle body above the respective wheels, the sensors include one of a 6D sensor and a body G sensor, and
wherein,
when the sensors include the 6D sensor, the 6D sensor measures a vertical acceleration of a center of mass of the vehicle body, a roll rate and a pitch rate, and when the sensors include the body G sensor, the body G sensor is mounted at each of three sections among a total of four sections of the vehicle body provided with the respective wheels; and
in the estimating the vertical speeds of the vehicle body above the respective wheels, the vertical speeds of the vehicle body above the respective wheels are estimated by receiving information about the vertical acceleration of the center of mass of the vehicle body, the roll rate and the pitch rate through the sensors.

15. The damper control method for the vehicle according to claim 14,
wherein, in the estimating the vertical speeds of the vehicle body above the respective wheels, the vertical accelerations of the three sections among the four sections of the vehicle body above the respective wheels, measured through the sensors, are received, the vertical speed of the center of mass of the vehicle body is derived using the vertical accelerations of the three sections of the vehicle body above the respective wheels, and a vertical speed of a remaining one section among the four sections of the vehicle body above the respective wheels is determined using the vertical speed of the center of mass of the vehicle body, the roll rate and the pitch rate.

16. The damper control method for the vehicle according to claim 15,
wherein, in the deriving the forces acting on the regions above the respective front wheels, vertical accelerations of the vehicle body above the respective rear wheels are derived by integrating the vertical speeds of the vehicle body above the rear wheels, and forces acting on the regions above the respective rear wheels are derived using the vertical accelerations of the vehicle body above the rear wheels.

17. The damper control method for the vehicle according to claim 16,
wherein, in the primarily determining the relative vertical speeds of the respective front wheels and determining the vertical speeds of the respective front wheels, the forces acting on the regions above the respective front wheels depending on a situation in which the roll rate and the pitch rate occur are derived, and the relative vertical speeds of the respective front wheels with respect to the vertical speeds of the vehicle body above the respective front wheels are determined using the forces acting on the regions above the respective front wheels.

18. The damper control method for the vehicle according to claim 17,
wherein, in the estimating the vertical speeds of the respective rear wheels after the delay and secondarily determining the relative vertical speeds of the respective rear wheels, the vertical speeds of the respective front wheels are determined using the relative vertical speeds of the respective front wheels, a delay caused by a wheelbase between the front and rear wheels and a vehicle speed is derived, the vertical speeds of the respective rear wheels after the delay compared to the vertical speeds of the respective front wheels are derived, and the relative vertical speeds of the respective rear wheels with respect to the vertical speeds of the vehicle body above the respective rear wheels are determined using the vertical speeds of the respective rear wheels.
